(19) United States
(12) Patent Application Publication
(10) Pub. No.: US 2016/0146435 A1
(43) Pub. Date: May 26, 2016

(54) Light Emitting Module and Lighting Apparatus Including the Same

(71) Applicant: LG INNOTEK CO., LTD., Seoul (KR)

(72) Inventors: Chang Gyun SON, Seoul (KR); Bo Ra KANG, Seoul (KR); Ki Cheol KIM, Seoul (KR); Sung Phil KIM, Seoul (KR); Kang Yeol PARK, Seoul (KR); Yang Hyun JOO, Seoul (KR)

(21) Appl. No.: 14/950,623

(22) Filed: Nov. 24, 2015

(30) Foreign Application Priority Data
Nov. 24, 2014 (KR) 10-2014-0164435

(51) Int. Cl. F21V 19/00; F21K 99/00

(52) U.S. Cl. CPC F21V 19/0015; F21K 9/56; F21Y 2105/003

(57) ABSTRACT

Disclosed is a light emitting module which includes a base and a plurality of light sources arranged on the base. Here, at least some of the plurality of light sources have a rectangular planar shape, and the plurality of light sources are arranged so that at least one of long-axis direction or short-axis direction of at least some of the plurality of light sources are alternately changed in at least one of row direction or column direction.

### CROSS REFERENCE TO RELATED APPLICATION

This application claims the benefit under 35 U.S.C. §119 to Korean Patent Application No. 10-2014-0164435, filed Nov. 24, 2014, which is hereby incorporated by reference in its entirety.

### TECHNICAL FIELD

Embodiments relate to a light emitting module and a lighting apparatus including the same.

### BACKGROUND

Light emitting diodes are semiconductor devices that convert electricity into light such as infrared light using characteristics of compound semiconductors to send and receive signals, or are used as light sources.

Group III-V nitride semiconductor materials have come into the spotlight as core materials for light emitting devices (LEDs), such as light emitting diodes or laser diodes (LD), due to physical and chemical characteristics thereof.

Such light emitting diodes have excellent environmental friendliness since they include no environmentally hazardous substances, such as mercury (Hg), used for light fixtures such as incandescent lamps, fluorescent lamps, etc., and also have characteristics such as long lifespan, low power consumption, etc. Therefore, conventional light sources have been replaced with light emitting diodes.

When an LED has a rectangular planar shape, light distributions (or beam angles) of the LED may be different from each other on the long axis (or, major axis) and short axis (or, minor axis). In addition, even when the LED has a square planar shape, an LED package in which the LEDs with square planar shapes are arranged may have a rectangular planar shape. In this case, the same problems may be encountered.

In addition, when a fluorescent material or lens is applied to a top surface of the LED or the LED package, a difference in light distribution may become serious. Therefore, uniformity in light distribution of a light emitting module including the above-described LED package and a lighting apparatus including the light emitting module may also be degraded.

### BRIEF SUMMARY

Embodiments provide a light emitting module capable of providing improved light distribution, and a lighting apparatus including the same.

In one embodiment, a light emitting module includes a base, and a plurality of light sources arranged on the base, wherein at least some of the plurality of light sources have a rectangular planar shape, and the plurality of light sources are arranged so that at least one of long-axis direction or short-axis direction of at least some of the plurality of light sources are alternately changed in at least one of row direction or column direction.

In this case, the base may correspond to a package body having the plurality of light sources arranged thereon, and the plurality of light sources may correspond to a plurality of light emitting devices, respectively.

In addition, the base may correspond to a printed circuit board (PCB) having the plurality of light sources arranged thereon, and the plurality of light sources may correspond to a plurality of LED packages, respectively.

Additionally, each of the plurality of LED packages may include a package body arranged on the PCB, and at least one light emitting device arranged on the package body.

In addition, each of the plurality of LED packages may further include a first lens arranged on the package body, and a wavelength conversion unit arranged between the first lens and the package body.

Additionally, the at least one light emitting device may include a plurality of light emitting devices, and the plurality of light emitting devices may have at least one of square planar shape or rectangular planar shape.

Further, the plurality of light sources may be arranged in at least one shape selected from the group consisting of polygonal, diamond-type, and shift-type shapes to be spaced apart from each other.

In addition, at least some of the plurality of light sources may be arranged spaced apart from each other at the same intervals in at least one of row direction or column direction. Further, at least some of the plurality of light sources may be arranged spaced apart from each other at different intervals in at least one of row direction or column direction. Here, a spacing between the plurality of light sources in the row direction may be different from a spacing between the plurality of light sources in the column direction.

Additionally, the plurality of light sources may be divided into columns of plural light sources arranged in a row direction, and the plurality of light sources may be arranged so that at least one of short-axis direction or long-axis direction of the neighboring ones of the columns of plural light sources is changed in a row direction. The columns of plural light sources may be arranged so that the columns of even-numbered light sources are shifted at a predetermined distance in the column direction with respect to the columns of odd-numbered light sources. Here, the predetermined distance may be a half of a unit pitch in which a plurality of light sources belonging to each of the columns of light sources are spaced apart from each other in the column direction.

Further, the plurality of light sources may be divided into rows of plural light sources arranged in a column direction, and the plurality of light sources may be arranged so that at least one of short-axis direction or long-axis direction of the neighboring ones of the rows of plural light sources is changed in a column direction. The rows of plural light sources may be arranged so that the rows of even-numbered light sources are shifted at a predetermined distance in the column direction with respect to the rows of odd-numbered light sources. Here, the predetermined distance may be a half of a unit pitch in which a plurality of light sources belonging to each of the rows of light sources are spaced apart from each other in the row direction.

Additionally, each of the plurality of light sources may include a central light source, and peripheral light sources surrounding the central light source. Here, the short-axis direction of the central light source may be identical to the long-axis direction of the peripheral light sources. In addition, the long-axis direction of the central light source may be identical to the short-axis direction of the peripheral light sources.

Furthermore, the light emitting module may further include a second lens arranged on the plurality of LED packages.

In another embodiment, a lighting apparatus includes the light emitting module, and an optical member arranged on the light emitting module.

### BRIEF DESCRIPTION OF THE DRAWINGS

Arrangements and embodiments will be described in detail with reference to the following drawings in which like reference numerals refer to like elements and wherein:

FIG. 1 is a plan view showing a light emitting module according to one embodiment;

FIG. 2 is a cross-sectional view showing one embodiment taken along line I-I′ of the light emitting module shown in FIG. 1;

FIG. 3 is a cross-sectional view showing another embodiment taken along line I-I′ of the light emitting module shown in FIG. 1;

FIG. 4 is a plan view showing another embodiment of the light emitting module shown in FIG. 3;

FIG. 5 is a plan view showing still another embodiment of the light emitting module shown in FIG. 3;

FIG. 6 is a plan view showing yet another embodiment of the light emitting module shown in FIG. 3;

FIGS. 7A to 7D are plan views showing light emitting modules according to other embodiments;

FIGS. 8A to 8D are plan views showing light emitting modules according to still other embodiments;

FIG. 9 is a plan view showing a light emitting module according to yet another embodiment;

FIG. 10 is a plan view showing a light emitting module according to yet another embodiment;

FIG. 11 is a plan view showing a light emitting module according to yet another embodiment;

FIG. 12 is a cross-sectional view showing a lighting apparatus according to one embodiment;

FIGS. 13A and 13B are plan views showing light emitting modules according to one comparative embodiment;

FIGS. 14A and 14B are diagrams showing short-axis and long-axis light distributions of light emitting devices having a rectangular planar shape, respectively;

FIG. 15 is a diagram showing brightness distributions and chromaticity distributions of symmetrical and asymmetrical lighting apparatuses according to the comparative embodiment;

FIG. 16 is a diagram showing in-plane brightness and in-plane chromaticity distributions of the lighting apparatuses according to the comparative embodiment and the embodiments; and

FIG. 17 is a graph showing illuminance distributions of the lighting apparatuses according to the comparative embodiment and the embodiments as shown in FIG. 16.

### DETAILED DESCRIPTION

Hereinafter, embodiments will be described with reference to the annexed drawings. However, it should be understood that the following embodiments of the present invention may be changed in various forms, and thus are not intended to limit the scope of the present invention. Thus, the embodiments of the present invention are provided to describe the present invention more completely, as apparent to those skilled in the art.

It will be understood that when an element is referred to as being “on” or “under” another element, it can be directly on/under the element, and one or more intervening elements may also be present. When an element is referred to as being “on” or “under”, “under the element” as well as “on the element” can be included based on the element.

In addition, the relative terms “first,” “second,” “top,” “bottom,” etc. used herein may be only used to distinguish any entities or elements from each other without requiring or encompassing any physical or logical relationship between or order of the entities or elements.

In the drawings, the thicknesses or sizes of respective layers and regions may be exaggerated, omitted, or diminished for the sake of convenience and clarity of description. Additionally, the sizes of the respective components are not entirely intended to reflect the actual sizes thereof.

Hereinafter, light emitting modules 100A to 100M according to embodiments and a lighting apparatus 200 will be described in detail with reference to the accompanying drawings, as follows. For the sake of convenience, the light emitting modules 100A to 100M and the lighting apparatus 200 will be described using Cartesian coordinate systems (x, y, and z axes), but may also be described using other coordinate systems. According to the Cartesian coordinate systems, the x axis, the y axis, and the z axis are perpendicular to each other, but embodiments are not limited thereto. That is, the x axis, the y axis, and the z axis may intersect each other without being perpendicular to each other.

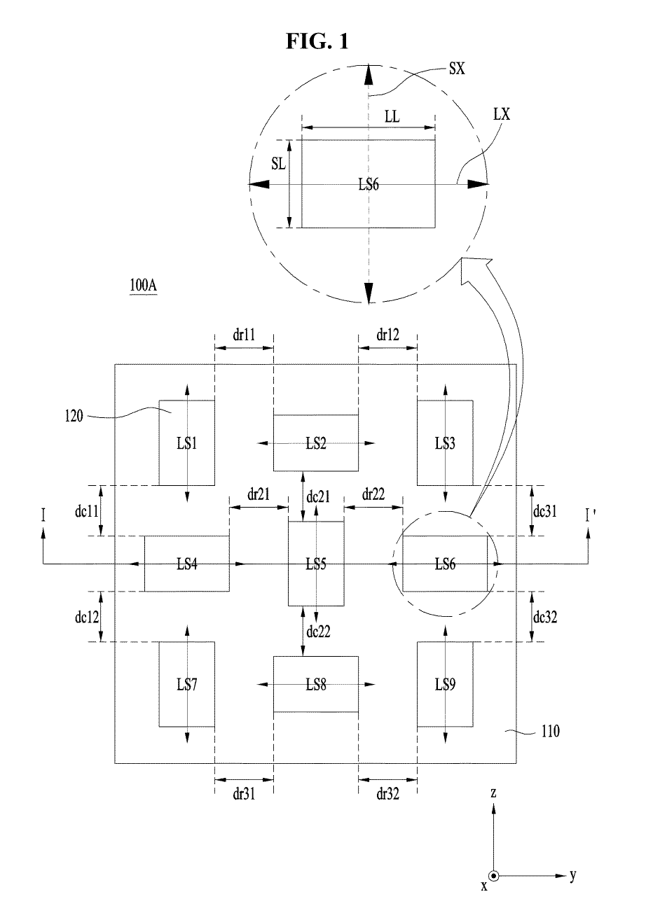

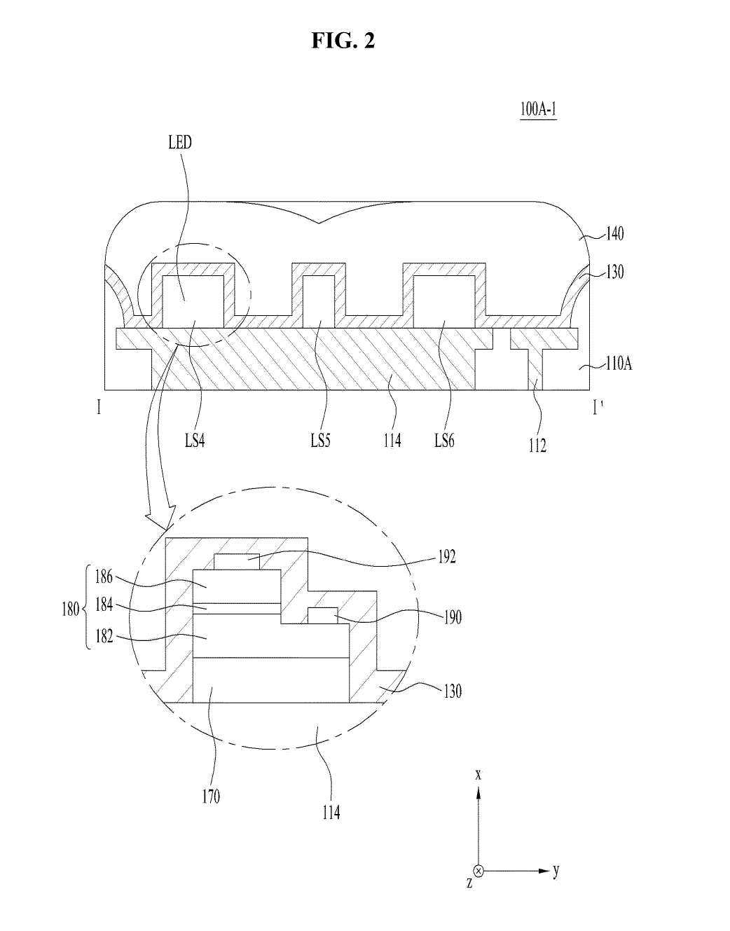

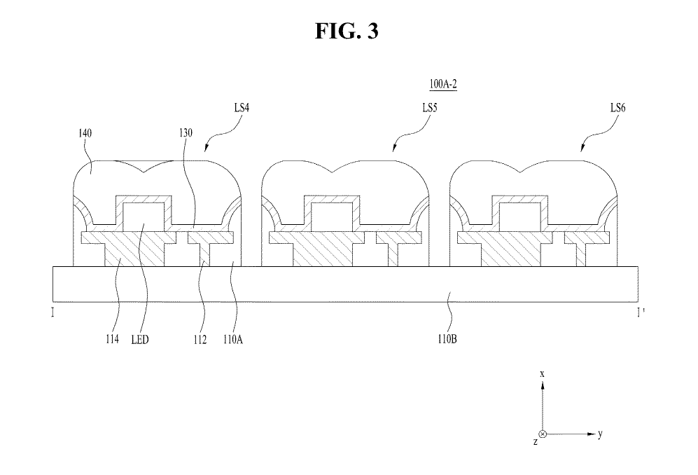

FIG. 1 is a plan view showing a light emitting module 100A according to one embodiment, FIG. 2 is a cross-sectional view showing one embodiment (100A-1) taken along line I-I′ of the light emitting module 100A shown in FIG. 1, and FIG. 3 is a cross-sectional view showing another embodiment (100A-2) taken along line I-I′ of the light emitting module 100A shown in FIG. 1.

The light emitting module 100A as shown in FIG. 1 may include a base 110 and a plurality of light sources 120.

The plurality of light sources 120 may be arranged on the base 110. A case in which nine light sources LS1 to LS9 are arranged on a base is shown in FIG. 1, but embodiments are not limited thereto. That is, according to other embodiments, up to 9 or at least 9 light sources 120 may be arranged on the base 110.

At least some of the plurality of light sources LS1 to LS9 shown in FIG. 1 may have a rectangular (or oblong) planar shape. A case in which all the plurality of light sources LS1 to LS9 have a rectangular planar shape is shown in FIG. 1, but embodiments are not limited thereto. That is, according to embodiments, only some of the plurality of light sources LS1 to LS9 may have a rectangular planar shape, and the others may have a square (or quadrate) planar shape, unlike in FIG. 1. Each of the light sources LS1 to LS9 having a rectangular planar shape may have a long-axis length (LL) (or, (or, major axis length) in a long-axis (LX) direction (or, major axis direction) and a short-axis length (SL) (or, minor axis length) in a short-axis (SX) direction (or, minor axis length). Here, long-axis and short-axis directions of each of the light sources LS1, LS3, LS5, LS7, and LS9 represent z-axis and y-axis directions, respectively, and long-axis and short-axis directions of each of the light sources LS2, LS4, LS6, and LS8 represent y-axis and z-axis directions, respectively.

Hereinafter, in the corresponding drawings, the long-axis direction is indicated by a solid-line arrow ( [symbol] ), and the short-axis direction is indicated by a dotted-line arrow ( [symbol] ) so as to avoid confusion between the long-axis direction and the short-axis direction. For convenience of description, a case in which the nine light sources LS1 to LS9 are arranged on the base 110 is also described herein, but a case in which the number of the light sources is less than 9 or greater than 9 may also be applied in the following detailed description.

According to one embodiment, the light emitting module 100A shown in FIG. 1 may be realized as shown in FIG. 2.

Referring to FIG. 2, the light emitting module 100A-1 may include a package body 110A, first and second lead frames 112 and 114, a light emitting device (LED), a wavelength conversion unit 130, and a first lens 140.

The base 110 shown in FIG. 1 may correspond to the package body 110A on which the plurality of light sources LS1 to LS9 are arranged as shown in FIG. 2, and the plurality of light sources LS1 to LS9 120 shown in FIG. 1 may correspond respectively to the LEDs shown in FIG. 2.

For convenience of description, the wavelength conversion unit 130 and the first lens 140 shown in FIG. 2 are omitted in FIG. 1.

The LED may be a light emitting diode chip, and the light emitting diode chip may be configured as a blue or ultraviolet light emitting diode chip, or may be configured in the form of a package as a combination of one or more selected from the group consisting of red, green, blue, yellow green, and white light emitting diode chips.

The LED may be a top-view-type light emitting diode, or a side-view-type light emitting diode.

The package body 110A may be formed of a material having reflectivity. In addition, the package body 110A may be formed of an epoxy molding compound (EMC), but embodiments are not limited to the material of the package body 110A.

The first and second lead frames 112 and 114 arranged in the package body 110A may be arranged spaced apart from each other in a direction (for example, a y-axis direction that is a direction perpendicular to the x-axis direction) intersecting with an x-axis direction that is a thickness direction of the light emitting structure 180. Each of the first and second lead frames 112 and 114 may be made of a conductive material, for example, a metal, but embodiments are not limited to the type of the material of each of the first and second lead frames 112 and 114. As an insulation layer, the package body 110A may be arranged between the first and second lead frames 112 and 114 so as to electrically isolate the first and second lead frames 112 and 114.

The LED may include a substrate 170, a light emitting structure 180, and first and second electrodes 190 and 192.

The light emitting structure 180 may be arranged on the substrate 170. The substrate 170 may be formed of a material suitable for growth of semiconductor materials, or a carrier wafer. In addition, the substrate 170 may be formed of a material having excellent thermal conductivity, or may be an insulating substrate. For example, the substrate 170 may be formed of a material including at least one selected from the group consisting of sapphire (Al₂0₃), GaN, SiC, ZnO, Si, GaP, InP, Ga₂0₃, GaAs, and Ge. An uneven pattern may be formed on a top surface of the substrate 170. For example, although not shown, the substrate 170 may be a patterned sapphire substrate (PSS).

In addition, a buffer layer (not shown) may be arranged between the substrate 170 and the light emitting structure 180. The buffer layer may be formed using a Group III-V compound semiconductor material. The buffer layer serves to reduce a difference in lattice constant between the substrate 170 and the light emitting structure 180. For example, the buffer layer may include aluminum nitride (AlN), or an undoped nitride, but the disclosure is not limited thereto. The buffer layer may be omitted, depending on the types of the substrate 170 and the light emitting structure 180.

The light emitting structure 180 may include a first conductive semiconductor layer 182, an active layer 184, and a second conductive semiconductor layer 186.

The first conductive semiconductor layer 182 is arranged on the substrate 170. The first conductive semiconductor layer 182 may be arranged between the substrate 170 and the active layer 184, and may include a semiconductor compound. Here, the first conductive semiconductor layer 182 may be formed of Group III-V and Group II-VI compound semiconductor materials, and may also be doped with a first conductive dopant. For example, the first conductive semiconductor layer 182 may include a semiconductor material having a composition expression of AlₓIn_{y}Ga_{(1-x-y)}N (0≦x≦1, 0≦y≦1, 0≦x+y≦1), or may include at least one selected from the group consisting of InAlGaN, AlGaAs, GaP, GaAs, GaAsP, and AlGaInP. When the first conductive semiconductor layer 182 is an n-type semiconductor layer, the first conductive dopant may include n-type dopants such as Si, Ge, Sn, Se, Te, etc. The first conductive semiconductor layer 182 may have a single-layered or multilayered structure, but the disclosure is not limited thereto.

The active layer 184 may be arranged between the first conductive semiconductor layer 182 and the second conductive semiconductor layer 186. The active layer 184 may have one structure selected from the group consisting of a single well structure, a double heterostructure, a multiple well structure, a single quantum well structure, a multiple quantum well (MQW) structure, a quantum dot structure, and a quantum wire structure. The active layer 184 may have a pair structure of a well layer and a barrier layer, for example, at least one pair structure selected from the group consisting of AlGaN/AlGaN, InGaN/GaN, InGaN/InGaN, GaN/AlGaN, AlGaN/GaN, InAlGaN/GaN, GaAs(InGaAs)/AlGaAs, and GaP(InGaP)/AlGaP, which is formed using Group III-V compound semiconductor materials, but the disclosure is not limited thereto. The well layer may be made of a material having a lower energy band gap than the barrier layer. The second conductive semiconductor layer 186 may be arranged on the active layer 184, and may include a semiconductor compound. The second conductive semiconductor layer 186 may be formed of Group III-V and Group II-VI compound semiconductor materials, and may, for example, include a semiconductor material having a composition expression of InₓAl_{y}Ga_{1-x-y}N (0≦x≦1, 0≦y≦1, and 0≦x+y≦1), or may include at least one selected from selected from the group consisting of AlInN, AlGaAs, GaP, GaAs, GaAsP, and AlGaInP.

When the second conductive semiconductor layer 186 is a p-type semiconductor layer, the second conductive dopant may include p-type dopants such as Mg, Zn, Ca, Sr, Ba, etc. The second conductive semiconductor layer 186 may have a single-layered or multilayered structure, but the disclosure is not limited thereto.

The first conductive semiconductor layer 182 may be realized as an n-type semiconductor layer, and the second conductive semiconductor layer 186 may be realized as a p-type semiconductor layer. On the other hand, the first conductive semiconductor layer 182 may be realized as a p-type semiconductor layer, and the second conductive semiconductor layer 186 may be realized as an n-type semiconductor layer. Therefore, the light emitting structure 180 may include at least one selected from the group consisting of n-p junction, p-n junction, n-p-n junction, and p-n-p junction structures.

A first electrode 190 is arranged on the first conductive semiconductor layer 182 which is exposed by subjecting the second conductive semiconductor layer 186, the active layer 184, and a portion of the first conductive semiconductor layer 182 to mesa etching. A second electrode 192 is arranged on the second conductive semiconductor layer 186.

The light emitting device LED may have a horizontal bonding structure as shown in FIG. 2, but embodiments are not limited thereto. The LED may also have a vertical bonding structure or a flip-chip bonding structure. As described above, each of the light sources LS1 to LS9 shown in FIG. 1 may have a horizontal bonding structure, a vertical bonding structure or a flip-chip bonding structure, as shown in FIG. 2. As such, all the LEDs LS1 to LS9 may have the same bonding structure. According to another embodiment, the LEDs LS1 to LS9 may have different bonding structures. That is, some of the LEDs LS1 to LS9 may have a horizontal bonding structure, some of the LEDs LS1 to LS9 may have a vertical bonding structure, and the others may have a flip-chip bonding structure.

In addition, a case in which the LED is arranged on the second lead frame 114 is shown in FIG. 2, but embodiments are not limited thereto. That is, the LED may be arranged on the first lead frame 112.

Additionally, although not shown, when the LED have a horizontal bonding structure, the first electrode 190 of the LED may be electrically coupled to the first lead frame 112 through a first wire, and the second electrode 192 may be electrically coupled to the second lead frame 114 through a second wire.

Further, although not shown, a Zener diode may be further arranged on the package body 110A.

The wavelength conversion unit 130 may be arranged between the first lens 140 and the package body 110A. The wavelength conversion unit 130 serves to convert wavelengths of light emitted from the light sources 120. For this purpose, the wavelength conversion unit 130 may, for example, be formed of silicon (Si), and may include a phosphor (or a phosphorescent material), and thus may convert wavelengths of light emitted from the light sources 120. The phosphor may include at least one fluorescent material (i.e., a wavelength conversion means) selected from the group consisting of YAG-based, TAG-based, silicate-based, sulfide-based, and nitride-based fluorescent materials, all of which may be used to convert light emitted from the light sources 120 into white light, but embodiments are not limited to the type of the phosphor.

The YAG- and TAG-based fluorescent materials that may be used herein may be chosen from (Y, Tb, Lu, Sc, La, Gd, and Sm)₃(Al, Ga, In, Si, and Fe)₅(O and S)₁₂:Ce, and the silicate-based fluorescent material that may be used herein may be chosen from (Sr, Ba, Ca, and Mg)₂SiO₄:(Eu, F, and Cl).

In addition, the sulfide-based fluorescent material that may be used herein may be chosen from (Ca,Sr)S:Eu, and (Sr,Ca,Ba)(Al,Ga)₂S₄:Eu, and the nitride-based phosphor that may be used herein may be chosen from phosphor components such as (Sr, Ca, Si, Al, and O)N:Eu (e.g., CaAlSiN₄:Eu, and β-SiAlON:Eu), or Ca-α SiAlON:Eu (e.g., Caₓ, M_{y})(Si, Al)₁₂(O,N)₁₆ where M represents at least one material selected from the group consisting of Eu, Tb, Yb, and Er, 0.05<(x+y)<0.3, 0.02<x<0.27, and 0.03<y<0.3.

A nitride-based phosphor containing N (e.g., CaAlSiN₃:Eu) may be used as the red phosphor. Such a nitride-based red phosphor may have superior reliability under external environments such as heat and moisture, and a low risk of discoloration, compared to the sulfide-based phosphor.

The first lens 140 may be arranged on the package body 110A. The first lens 140 may be arranged on the wavelength conversion unit 130 so that light passing the wavelength conversion unit 130 is incident to the first lens 140, the incident light is refracted and/or reflected by, and then emitted from the first lens 140. The first lens 140 may include a transparent material, for example, silicon (Si), polycarbonate (PC), acrylic resins (i.e., polymethyl methacrylate (PMMA)), glass, etc.

In addition, the first lens 140 may have various shapes such as spherical and non-spherical shapes, but embodiments are not limited as to the shape of the first lens 140.

According to other embodiments, the light emitting module 100A shown in FIG. 1 may be realized as shown in FIG. 3.

Referring to FIG. 3, a light emitting module 100A-2 may include a PCB 110B, and a plurality of LED packages LS1 to LS9. The base 110 shown in FIG. 1 may correspond to the PCB 110B shown in FIG. 3, and the plurality of light sources LS1 to LS9 shown in FIG. 1 may correspond to the LED packages shown in FIG. 3, respectively.

Each of the plurality of LED packages (for example, LS4, LS5, and LS6) shown in FIG. 3 may have the same structure as the light emitting module 100A-1 shown in FIG. 2. That is, each of the plurality of LED packages (for example, LS4, LS5, and LS6) may include a package body 110A, first and second lead frames 112 and 114, a light emitting device LED, a wavelength conversion unit 130, and a first lens 140. Here, since each of the LED packages (LS4, LS5, and LS6) includes the same components as shown in FIG. 2, like components have like reference numerals, and thus description of the same components is omitted for clarity.

The package body 110A of each of the plurality of LED packages (for example, LS4 to LS6) is arranged on the PCB 110B. In this case, at least one LED may be arranged on the package body 110A.

The PCB 110B may have an electrode pattern formed therein for connecting the light sources 120 to an adaptor for supplying power. For example, an electrode pattern for connecting the adaptor to the light sources 120 may be formed on an upper surface of the PCB 110B.

Such a PCB 110B may be a substrate made of at least one material selected from the group consisting of polyethylene terephthalate (PET), glass, PC, and silicon (Si), and may be in the form of a film.

Additionally, a single-layered PCB, a multilayered PCB, a ceramic substrate, and a metal core PCB may be selectively used as the PCB 110B.

As a result, the base 110 shown in FIG. 1 may be the package body 110A shown in FIG. 2, and the light sources 120 shown in FIG. 1 may be the LEDs shown in FIG. 2. In this case, the long-axis direction of each of the light sources LS1 to LS9 may correspond to the long-axis direction of the LEDs, and the short-axis direction of each of the light sources LS1 to LS9 may correspond to the short-axis direction of the LEDs.

In addition, the base 110 shown in FIG. 1 may be the PCB 110B shown in FIG. 3, and the light sources 120 shown in FIG. 1 may be the LED packages LS4, LS5, and LS6 shown in FIG. 3. In this case, the long-axis direction of each of the light sources LS1 to LS9 may correspond to the long-axis direction of the LED packages, and the short-axis direction of each of the light sources LS1 to LS9 may correspond to the short-axis direction of the LED packages.

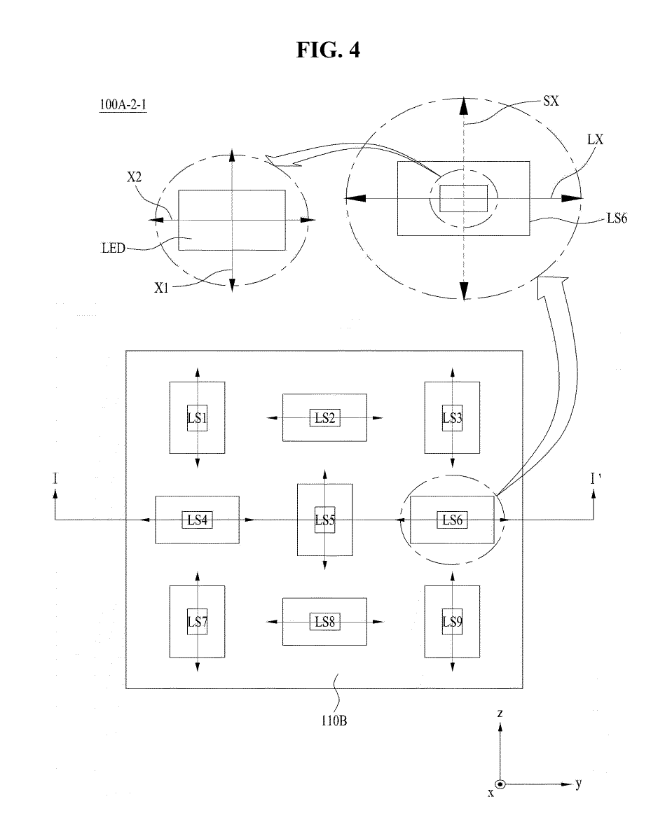

FIG. 4 is a plan view showing another embodiment (100A-2-1) of the light emitting module 100A-2 shown in FIG. 3.

FIG. 1 is a plan view showing one embodiment of the light emitting module 100A-2 shown in FIG. 3, and FIG. 4 is a plan view showing another embodiment of the light emitting module 100A-2 shown in FIG. 3.

Referring to FIGS. 3 and 4, each of the LED packages LS1 to LS9 is shown to include one LED. Here, the LED included in each of the LED packages LS1 to LS9 may have a rectangular or square planar shape.

Referring to FIG. 4, a first axis X1 and a second axis X2 of the LED having a square planar shape may have the same length. In addition, the first axis X1 of the LED having a rectangular planar shape may represent a long axis LX, and the second axis X2 may represent a short axis SX, or the first axis X1 of the LED having a rectangular planar shape may represent a short axis SX, and the second axis X2 may represent a long axis LX.

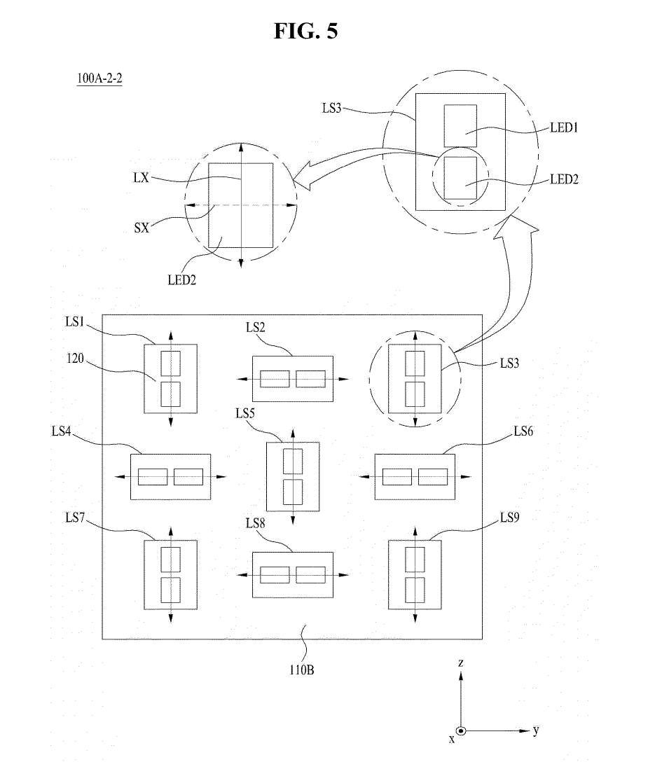

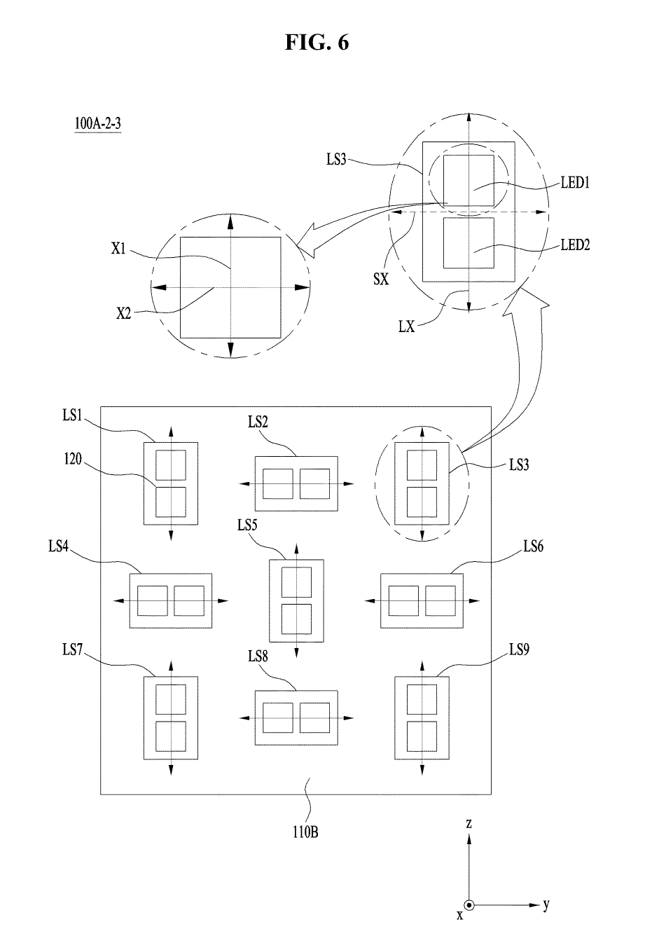

FIG. 5 is a plan view showing still another embodiment (100A-2-2) of the light emitting module 100A-2 shown in FIG. 3 and FIG. 6 is a plan view showing yet another embodiment (100A-2-3) of the light emitting module 100A-2 shown in FIG. 3.

Each of the LED packages LS1 to LS9 shown in FIG. 3 includes only one LED, but embodiments are not limited thereto. For example, each of the LED packages LS1 to LS9 may include a plurality of LEDs. For example, as the light sources, each of the LED packages LS1 to LS9 as the light source may include two LEDs (LED1 and LED2), as shown in FIG. 5 or 6.

When two LEDs rather than one LED are arranged side by side on the package body 110A in a y-axis direction unlike in the cross-sectional view shown in FIG. 3, FIG. 3 corresponds to the cross-sectional view of each of the light emitting modules 100A-2-2 and 100A-2-3 shown in FIGS. 5 and 6.

In addition, the plurality of LEDs included in each of the LED packages LS1 to LS9 may have at least one planar shapes of square or rectangular planar shapes.

For example, each of the two LEDs included in each of the LED packages LS1 to LS9 may have a rectangular planar shape, as shown in FIG. 5. That is, each of the two LEDs (LED1 and LED2) may have a long-axis length (LL) in a long-axis (LX) direction and a short-axis length (SL) in a short-axis (SX) direction which are different from each other.

In addition, each of the two LEDs (LED1 and LED2) included in each of the LED packages LS1 to LS9 may have a square planar shape, as shown in FIG. 6. That is, each of the two LEDs (LED1 and LED2) may have the same lengths in the first and second axes.

Additionally, although not shown, one of the two LEDs (LED1 and LED2) included in each of the LED packages LS1 to LS9 may have a rectangular planar shape as shown in FIG. 5, and the others may have a square planar shape as shown in FIG. 6.

Meanwhile, the plurality of light sources LS1 to LS9 may be arranged so that at least one of long-axis or short-axis directions of at least some of the plurality of light sources LS1 to LS9 is alternately changed in a y-axis direction, that is, a row direction, or a z-axis direction, that is, a column direction.

Referring again to FIG. 1, for example, at least some of the plurality of light sources LS1 to LS9, that is, three light sources LS1, LS2, and LS3 may be arranged so that the long-axis directions of the light sources LS1, LS2, and LS3 is alternately changed in a y-axis direction.

That is, the long-axis direction of each of the light sources LS1, LS2, and LS3 may be alternately changed in z-axis, y-axis and z-axis directions, along the y-axis direction. In addition, at least some of the plurality of light sources LS1 to LS9, that is, the three light sources LS1, LS2, and LS3 may be arranged so that the short-axis directions of the light sources LS1, LS2, and LS3 is alternately changed in a y-axis direction. That is, the short-axis direction of each of the light sources LS1, LS2, and LS3 may be alternately changed in y-axis, z-axis and y-axis directions, along the y-axis direction. As described above, the long-axis and short-axis directions of each of the three light sources LS1, LS2, and LS3 may be alternately changed in the y-axis direction.

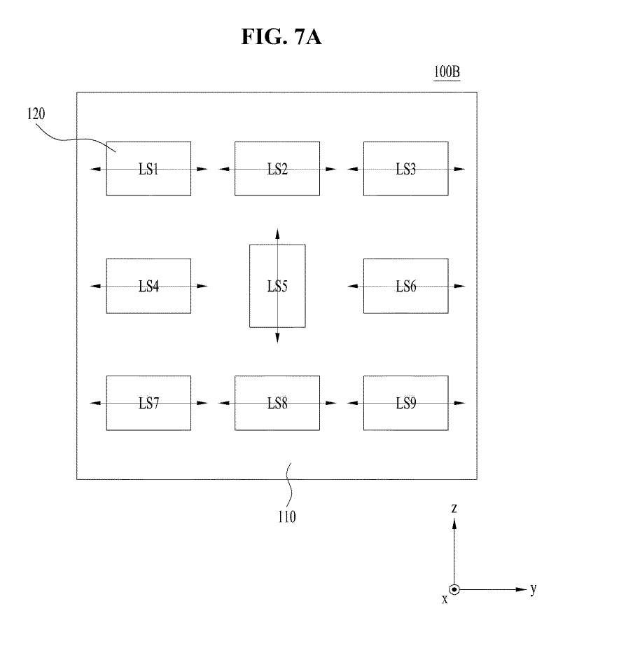

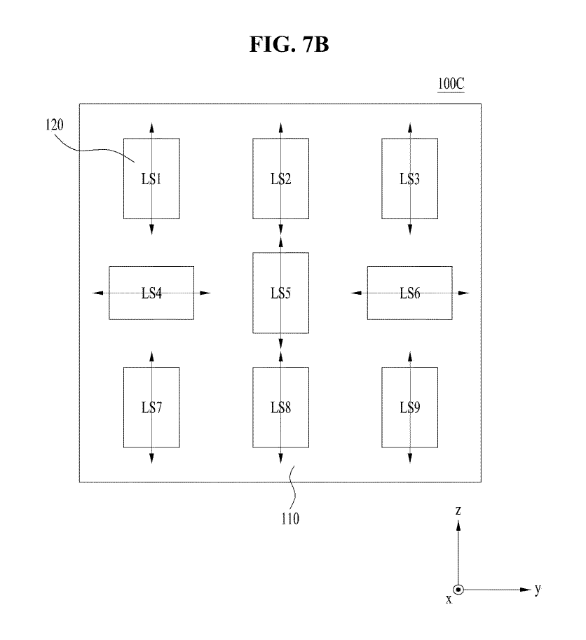

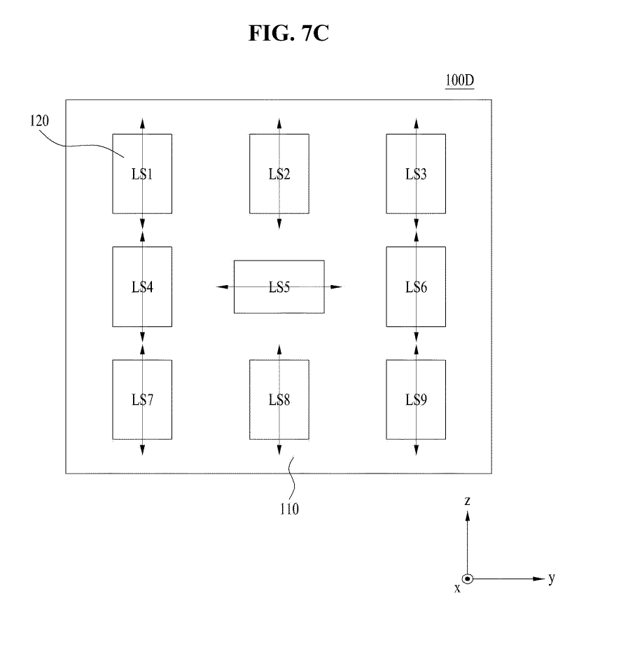

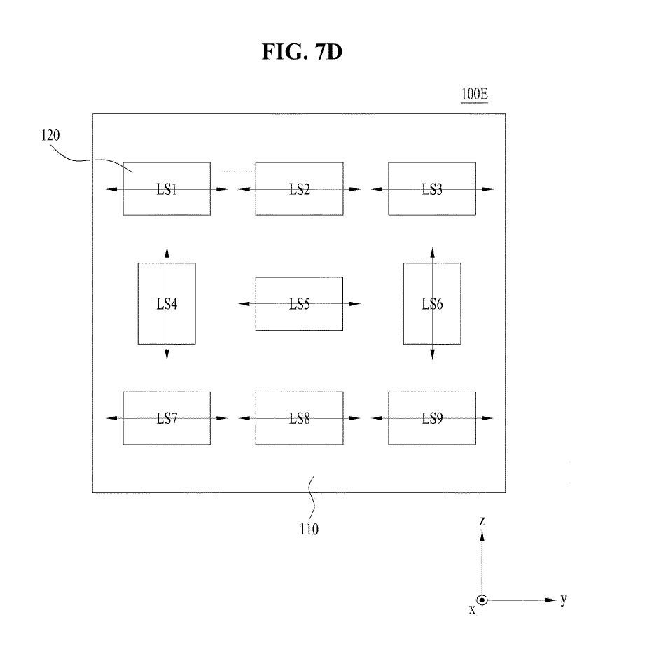

FIGS. 7A to 7D are plan views showing light emitting modules 100B to 100E according to other embodiments.

A case in which the long-axis and short-axis directions of all the light sources LS1 to LS9 are alternately changed in a row or column direction is shown in FIG. 1, embodiments are not limited thereto. That is, according to other embodiments, at least one of the long-axis or short-axis direction of some of the light sources LS1 to LS9 may be alternately changed in a row or column direction, and at least one of the long-axis or short-axis direction of the other light sources may be the same without being changed in a row or column direction.

For example, the long-axis directions of three light sources LS4, LS5, and LS6 may be alternately changed in y-axis, z-axis and y-axis directions along a y-axis direction, that is, a row direction, as shown in FIGS. 7A and 7B, and the short-axis direction of the three light sources LS4, LS5, and LS6 may be alternately changed in z-axis, y-axis and z-axis directions along a y-axis direction, that is, the row direction.

However, the long-axis directions of the other light sources LS1, LS2, LS3, LS7, LS8, and LS9 shown in FIG. 7A may be maintained in the same y-axis direction, that is, a row direction without being changed in the y-axis direction, and the short-axis directions of the light sources LS1, LS2, LS3, LS7, LS8, and LS9 may be maintained in the same z-axis direction without being changed in the row direction. In addition, the short-axis directions of the other light sources LS1, LS2, LS3, LS7, LS8, and LS9 may be maintained in the same y-axis direction along the row direction, and the long-axis directions of the light sources LS1, LS2, LS3, LS7, LS8, and LS9 may be maintained in the same z-axis direction along the row direction, as shown in FIG. 7B.

In addition, the long-axis directions of the three light sources LS4, LS5, and LS6 may be alternately changed in z-axis, y-axis and z-axis directions along a y-axis direction, that is, a row direction, and the short-axis directions of the light sources LS4, LS5, and LS6 may be alternately changed in y-axis, z-axis and y-axis directions along a y-axis direction, that is, a row direction, as shown in FIGS. 7C and 7D.

However, the long-axis directions of the other light sources LS1, LS2, LS3, LS7, LS8, and LS9 may be maintained in the same z-axis direction (row direction) without being changed in a y-axis direction, and the short-axis direction of the light sources LS1, LS2, LS3, LS7, LS8, and LS9 may be maintained in the same y-axis direction without being changed in the y-axis direction (row direction), as shown in FIG. 7C. Or, the short-axis directions of the other light sources LS1, LS2, LS3, LS7, LS8, and LS9 may be maintained in the same z-axis direction along the y-axis direction (row direction), and the long-axis directions of the light sources LS1, LS2, LS3, LS7, LS8, and LS9 may be maintained in the same y-axis direction along the y-axis direction (row direction), as shown in FIG. 7D.

As described above, in the plurality of light sources LS1 to LS9, the long-axis directions (or short-axis directions) of the three light sources (LS1 to LS3), (LS4 to LS6), or (LS7 to LS9) may be alternately changed in a y-axis direction (row direction).

Additionally, in the plurality of light sources LS1 to LS9, the long-axis directions (or short-axis directions) of the three light sources (LS1, LS4, and LS7), (LS2, LS5, and LS8), or (LS3, LS6, and LS9) may be alternately changed in a z-axis direction (column direction).

In addition, the long-axis and short-axis directions of the plurality of light sources LS1 to LS9 may be alternately changed in a y-axis direction (row direction), or in a z-axis direction (column direction), as shown in FIG. 1.

Further, the long-axis and short-axis directions of the plurality of light sources LS1 to LS9 may be alternately changed in the row direction (or column direction), but may be maintained in the same direction without being alternately changed in the column direction (or row direction).

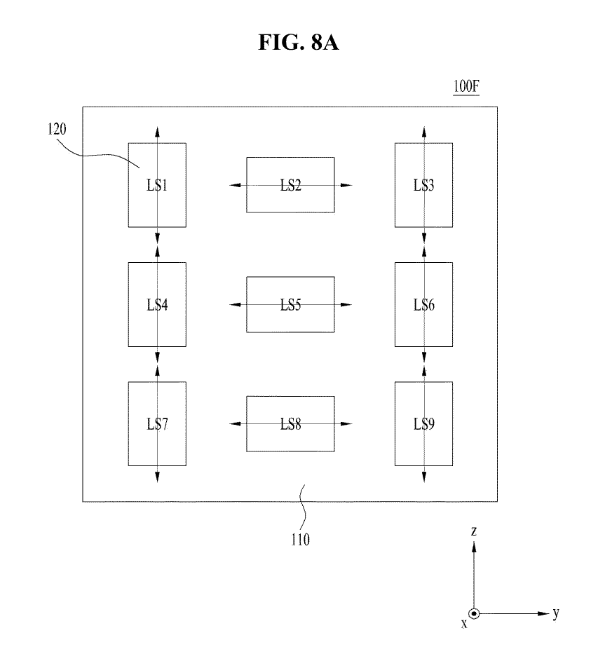

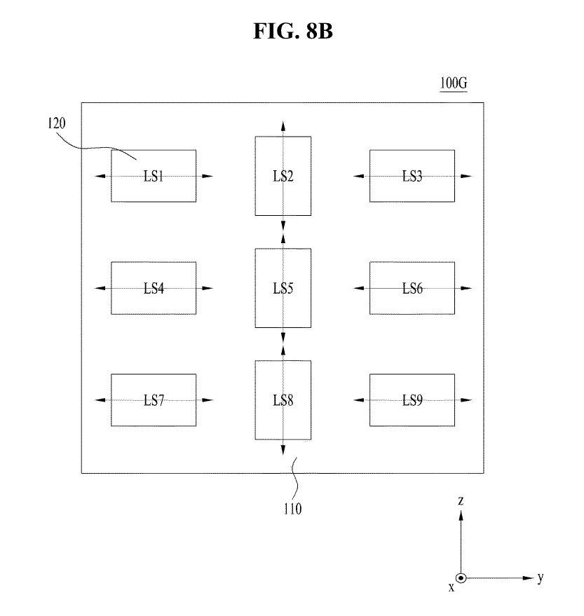

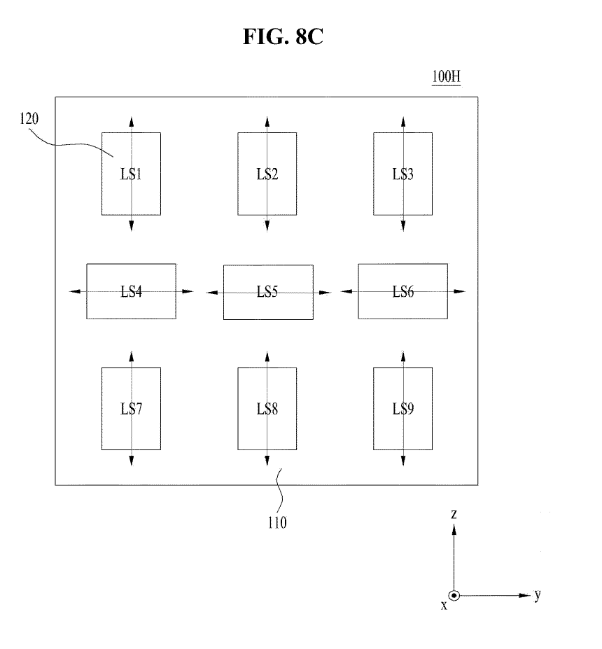

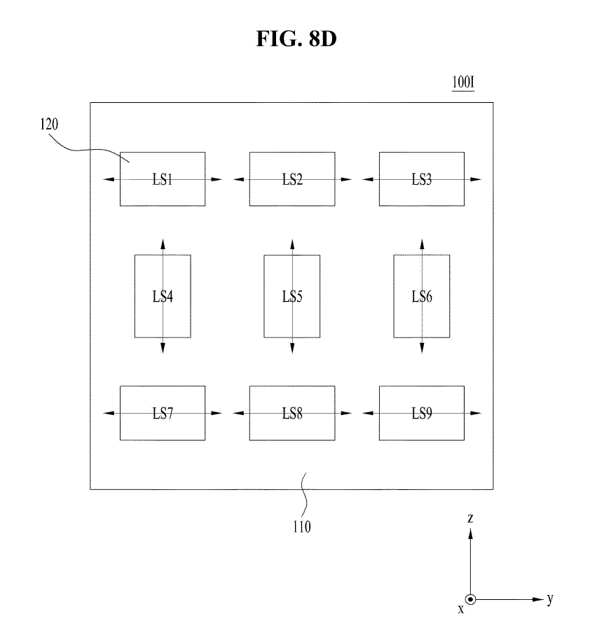

FIGS. 8A to 8D are plan views showing light emitting modules 100F to 100I according to still other embodiments.

Referring to FIG. 8A, for example, the long-axis directions of each of the light sources (LS1, LS2, and LS3), (LS4, LS5, and LS6), and (LS7, LS8, and LS9) are alternately changed in z-axis, y-axis and z-axis direction along a y-axis direction (row direction), and the short-axis directions of each of the light sources (LS1, LS2, and LS3), (LS4, LS5, and LS6), and (LS7, LS8, and LS9) are alternately changed in y-axis, z-axis and y-axis directions along the y-axis direction (row direction). However, the long-axis directions, that is, z-axis directions, of each of the light sources (LS1, LS4, and LS7) and (LS3, LS6, and LS9) may be maintained in the same direction without being alternately changed in a z-axis direction (column direction), and the short-axis directions, that is, y-axis directions, of each of the light sources (LS1, LS4, and LS7) and (LS3, LS6, and LS9) may be maintained in the same direction without being alternately changed in a z-axis direction (column direction). In addition, the long-axis direction, that is, a y-axis direction, of each of the light sources LS2, LS5, and LS8 may be maintained in the same direction without being alternately changed in a z-axis direction (column direction), and the short-axis direction, that is, a z-axis direction, of each of the light sources LS2, LS5, and LS8 may be maintained in the same direction without being alternately changed in a z-axis direction (column direction).

In addition, referring to FIG. 8B, the long-axis directions of each of the light sources (LS1, LS2, and LS3), (LS4, LS5, and LS6), and (LS7, LS8, and LS9) are alternately changed in y-axis, z-axis and y-axis directions along the y-axis direction (row direction), and the short-axis directions of each of the light sources (LS1, LS2, and LS3), (LS4, LS5, and LS6), and (LS7, LS8, and LS9) are alternately changed in z-axis, y-axis and z-axis directions along the y-axis direction (row direction). However, the long-axis directions, that is, y-axis directions, of each of the light sources (LS1, LS4, and LS7) and (LS3, LS6, and LS9) may be maintained in the same direction without being alternately changed in a z-axis direction (column direction), and the short-axis directions, that is, z-axis directions, of each of the light sources (LS1, LS4, and LS7) and (LS3, LS6, and LS9) may be maintained in the same direction without being alternately changed in a z-axis direction (column direction). In addition, the long-axis direction, that is, a z-axis direction, of each of the light sources LS2, LS5, and LS8 may be maintained in the same direction without being alternately changed in a z-axis direction (column direction), and the short-axis direction, that is, a y-axis direction, of each of the light sources LS2, LS5, and LS8 may be maintained in the same direction without being alternately changed in a z-axis direction (column direction).

Additionally, referring to FIG. 8C, the long-axis directions of each of the light sources (LS1, LS4, and LS7), (LS2, LS5, and LS8), and (LS3, LS6, and LS9) may be alternately changed in z-axis, y-axis and z-axis directions along the z-axis direction (column direction), and the short-axis directions of each of the light sources (LS1, LS4, and LS7), (LS2, LS5, and LS8), and (LS3, LS6, and LS9) may be alternately changed in y-axis, z-axis and y-axis directions along the z-axis direction (column direction). However, the long-axis directions of each of the light sources (LS1, LS2, and LS3) and (LS7, LS8, and LS9) may be maintained in the same z-axis direction without being alternately changed in a y-axis direction (row direction), and the short-axis directions of each of the light sources (LS1, LS2, and LS3) and (LS7, LS8, and LS9) may be maintained in the same y-axis direction without being alternately changed in a y-axis direction (row direction). In addition, the long-axis direction of each of the light sources LS4, LS5, and LS6 may be maintained in the same y-axis direction (row direction) without being alternately changed in the y-axis direction, and the short-axis direction of each of the light sources (LS4, LS5, and LS6) may be maintained in the same z-axis direction without being alternately changed in the y-axis direction (row direction).

Referring to FIG. 8D, the long-axis directions of each of the light sources (LS1, LS4, and LS7), (LS2, LS5, and LS8), and (LS3, LS6, and LS9) may also be alternately changed in y-axis, z-axis and y-axis directions along the z-axis direction (column direction), and the short-axis directions of each of the light sources (LS1, LS4, and LS7), (LS2, LS5, and LS8), and (LS3, LS6, and LS9) may be alternately changed in z-axis, y-axis and z-axis directions along the z-axis direction (column direction). However, the long-axis directions of each of the light sources (LS1, LS2, and LS3) and (LS7, LS8, and LS9) may be maintained in the same y-axis direction (row direction) without being alternately changed in the y-axis direction, and the short-axis directions of each of the light sources (LS1, LS2, and LS3) and (LS7, LS8, and LS9) may be maintained in the same z-axis direction without being alternately changed in a y-axis direction (row direction). In addition, the long-axis direction of each of the light sources LS4, LS5, and LS6 may be maintained in the same z-axis direction without being alternately changed in a y-axis direction (row direction), and the short-axis direction of each of the light sources LS4, LS5, and LS6 may be maintained in the same y-axis direction (row direction) without being alternately changed in the y-axis direction.

Meanwhile, the plurality of light sources may be divided into columns of plural light sources or rows of plural light sources. Here, the expression “columns of light sources” refers to light sources arranged in a z-axis direction (column direction), and the expression “rows of light sources” refers to light sources arranged in a y-axis direction (row direction). The columns of plural light sources may be arranged in a y-axis direction (row direction), and the rows of plural light sources may be arranged in a z-axis direction (column direction).

Referring to FIG. 1, for example, the light sources LS1, LS2, and LS3 constitute a first row of light sources, the light sources LS4, LS5, and LS6 constitute a second row of light sources, and the light sources LS7, LS8, and LS9 constitute a third row of light sources. It can be seen that the first to third rows of light sources are arranged in a z-axis direction (column direction).

Additionally, the light sources LS1, LS4, and LS7 constitute a first column of light sources, the light sources LS2, LS5, and LS8 constitute a second column of light sources, and the light sources LS3, LS6, and LS9 constitute a third column of light sources. It can be seen that the first to third columns of light sources are arranged in a y-axis direction (row direction).

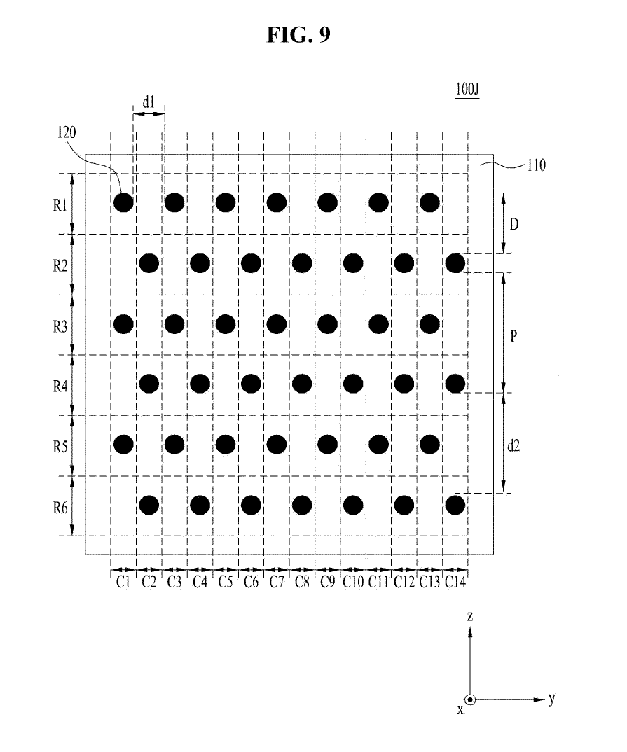

FIG. 9 is a plan view showing a light emitting module 100J according to yet another embodiment.

The light emitting module 100J shown in FIG. 9 may include a base 110, and a plurality of light sources 120 arranged on the base 110. Here, at least some of the plurality of light sources 120 may have a rectangular planar shape. That is, all of the plurality of light sources 120 shown in FIG. 9 may also have a rectangular planar shape. Or, some of the plurality of light sources 120 may have a rectangular planar shape, and the others may have a square planar shape.

In addition, the plurality of light sources 120 shown in FIG. 9 may be divided into first to fourteenth columns of light sources C1 to C14 arranged in a y-axis direction (row direction), and may also be divided into first to sixth rows of plural light sources R1 to R6 arranged in a z-axis direction (column direction).

According to one embodiment, at least one of the short-axis directions or long-axis directions of the neighboring ones of the columns of plural light sources may be changed in a row direction.

Referring to FIG. 1, for example, among the first column of light sources LS1, LS4, and LS7, the second column of light sources LS2, LS5, and LS8, and the third column of light sources LS3, LS6, and LS9, the first column of light sources LS1, LS4, and LS7 is adjacent to the second column of light sources LS2, LS5, and LS8, and the second column of light sources LS2, LS5, and LS8 is adjacent to the third column of light sources LS3, LS6, and LS9. In this case, the respective short-axis directions, that is, y-axis, z-axis and y-axis directions, of the first column of light sources LS1, LS4, and LS7, and the respective short-axis directions, that is, z-axis, y-axis and z-axis directions, of the neighboring second column of light sources LS2, LS5, and LS8 are alternately changed in a y-axis direction (row direction). That is, the short-axis direction, that is, a y-axis direction, of the light source LS1 belonging to the first column of light sources LS1, LS4, and LS7, and the short-axis direction, that is, a z-axis direction, of the light source LS2 belonging to the neighboring second column of light sources LS2, LS5, and LS8 are changed in the y-axis direction. Similarly, the respective short-axis directions, that is, z-axis, y-axis and z-axis directions, of the second column of light sources LS2, LS5, and LS8, and the respective short-axis directions, that is, y-axis, z-axis and y-axis directions, of the neighboring third column of light sources LS3, LS6, and LS9 are changed in the y-axis direction.

In addition, the respective long-axis directions, that is, z-axis, y-axis and z-axis directions, of the first column of light sources LS1, LS4, and LS7, and the respective long-axis directions, that is, y-axis, z-axis and y-axis directions, of the neighboring second column of light sources LS2, LS5, and LS8 are changed in the y-axis direction. That is, the long-axis direction, that is, a z-axis direction, of the light source LS1 belonging to the first column of light sources LS1, LS4, and LS7, and the long-axis direction, that is, a y-axis direction, of the light source LS2 belonging to the neighboring second column of light sources LS2, LS5, and LS8 are changed in the y-axis direction. Similarly, the respective long-axis directions, that is, y-axis, z-axis and y-axis directions, of the second column of light sources LS2, LS5, and LS8, and the respective long-axis direction, that is, z-axis, y-axis and z-axis directions, of the neighboring third column of light sources LS3, LS6, and LS9 are changed in the y-axis direction.

As shown in FIG. 1, the plurality of light sources 120 shown in FIG. 9 may be divided into columns of light sources.

In addition, among the columns of plural light sources C1 to C14, the columns of even-numbered light sources C2, C4, C6, C8, C10, C12, and C14 may be shifted by a predetermined distance D in a column direction with respect to the columns of odd-numbered light sources C1, C3, C5, C7, C9, C11, and C13, as described in the light emitting module 100J shown in FIG. 9. Or, among the columns of plural light sources C1 to C14, the columns of odd-numbered light sources C1, C3, C5, C7, C9, C11, and C13 may be shifted by a predetermined distance D in a column direction with respect to the columns of even-numbered light sources C2, C4, C6, C8, C10, C12, and C14.

For example, the fourteenth column of light sources C14 may be shifted by a predetermined distance D in a z-axis direction (column direction) with respect to the thirteenth column of light sources C13. Or, the thirteenth column of light sources C13 may be shifted by a predetermined distance D in a z-axis direction (column direction) with respect to the fourteenth column of light sources C14. Here, the predetermined distance D may be represented by the following Equation 1.

$$D = \frac{P}{2} \qquad Equation 1$$

wherein P may represent a unit pitch in which a plurality of light sources 120 belonging to each of the columns of light sources C1 to C14 are spaced apart from each other in a column direction.

Although not shown, the rows of plural light sources may be arranged in the same pattern as in the columns of light sources, as shown in FIGS. 1 and 9. That is, at least one of the short-axis or long-axis directions of the neighboring ones of the rows of plural light sources may be changed in a row direction. In addition, among the rows of plural light sources, the rows of even-numbered light sources may be shifted by a predetermined distance in a row direction with respect to the rows of odd-numbered light sources. Or, the rows of odd-numbered light sources may be shifted at a predetermined distance in a row direction with respect to the rows of even-numbered light sources. In this case, the predetermined distance may be represented by Equation 1.

In addition, the plurality of light sources included in the light emitting module according to one embodiment may include a central light source and peripheral light sources. Here, the peripheral light sources may refer to light sources surrounding the central light source. Referring to FIG. 1, for example, the light source LS5 may correspond to the central light source, and the light sources LS2, LS4, LS6, and LS8 may correspond to the peripheral light sources.

Additionally, the short-axis direction of the central light source may be the same as the long-axis direction of the peripheral light sources. Referring to FIG. 1, the short-axis direction of the light source LS5 as the central light source, and the long-axis directions of the light sources LS2, LS4, LS6, and LS8 as the peripheral light sources may be the same direction as the y-axis direction.

Further, the long-axis direction of the central light source may be the same as the short-axis direction of the peripheral light sources. Referring to FIG. 1, for example, the long-axis direction of the light source LS5 as the central light source, and the short-axis directions of the light sources LS2, LS4, LS6, and LS8 as the peripheral light sources may be the same as the z-axis direction.

Meanwhile, at least some of the plurality of light sources may be arranged spaced apart from each other by the same or different intervals in at least one of the row or column direction.

For example, the plurality of light sources LS1 to LS9 shown in FIG. 1 may be arranged spaced apart from each other at the same or different intervals in a y-axis direction (row direction). A distance dr11 between the light sources LS1 and LS2, a distance dr12 between the light sources LS2 and LS3, a distance dr21 between the light sources LS4 and LS5, a distance dr22 between the light sources LS5 and LS6, a distance dr31 between the light sources LS7 and LS8, and a distance dr32 between the light sources LS8 and LS9 may be the same as or different from each other.

In addition, the plurality of light sources LS1 to LS9 shown in FIG. 1 may be arranged spaced apart from each other by the same or different intervals in a z-axis direction (column direction). A distance dc11 between the light sources LS1 and LS4, a distance dc12 between the light sources LS4 and LS7, a distance dC21 between the light sources LS2 and LS5, a distance dc22 between the light sources LS5 and LS8, a distance dC31 between the light sources LS3 and LS6, and a distance dC32 between the light sources LS6 and LS9 may be the same as or different from each other.

Further, a spacing between the plurality of light sources arranged in a row direction, and a spacing between the plurality of light sources arranged in a column direction may be the same as or different from each other. For example, a spacing d1 between the plurality of light sources 120 arranged in a row direction may be lower than a spacing d2 between the plurality of light sources 120 arranged in a column direction, as shown in FIG. 9.

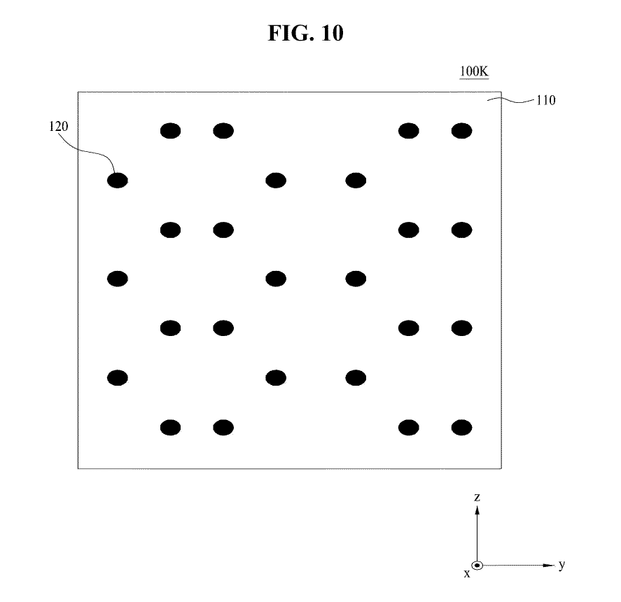

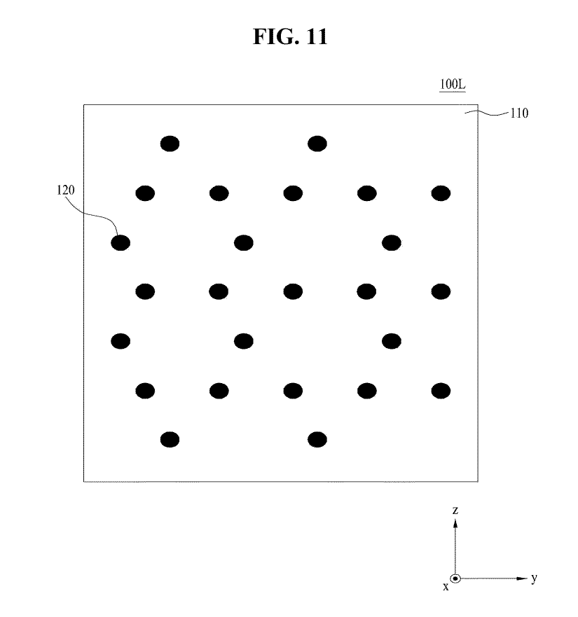

FIG. 10 is a plan view showing a light emitting module 100K according to yet another embodiment, and FIG. 11 is a plan view showing a light emitting module 100L according to yet another embodiment.

Each of the light emitting modules 100K and 100L shown in FIGS. 10 and 11 may include a base 110, and a plurality of light sources 120 arranged on the base 110. Here, at least some of the plurality of light sources 120 may have a rectangular planar shape. That is, all of the plurality of light sources 120 shown in FIG. 10 or 11 may also have a rectangular planar shape. Or, some of the plurality of light sources 120 may have a rectangular planar shape, and the others may have a square planar shape.

Meanwhile, the plurality of light sources may be arranged in at least one shape selected from the group consisting of zigzag, polygonal, diamond-type, and shift-type shapes to be spaced apart from each other. For example, the plurality of light sources 120 may be arranged in a tetragonal shape to be spaced apart from each other, as shown in FIGS. 1, 4 to 6, and 7A to 8D. Or, the plurality of light sources 120 may be arranged in a hexagonal shape to be spaced apart from each other, as shown in FIG. 10. Or, the plurality of light sources 120 may also be arranged in a shift-type shape to be spaced apart from each other, as shown in FIG. 9. In addition, the plurality of light sources 120 may be arranged in a diamond-type shape to be spaced apart from each other, as shown in FIG. 11.

As shown in FIG. 9, pitches between the light sources 120 included in the columns of light sources C1 to C14 are the same as each other, and pitches between the light sources 120 included in the rows of light sources R1 to R6 are the same as each other. On the other hand, the pitches between the light sources 120 arranged in a row or column direction may be different from each other, as shown in FIGS. 10 and 11.

The light emitting modules according to the above-described embodiments may be applied to various fields such as lighting apparatuses, display devices, indicating apparatuses, etc. For example, the lighting apparatuses may be efficiently used in fields such as linear modules, tubes, wall washers for emotional lighting, as well as ramps, street lights, etc.

Hereinafter, the lighting apparatus including the light emitting module according to the above-described embodiments will be described in detail with reference to the accompanying drawings.

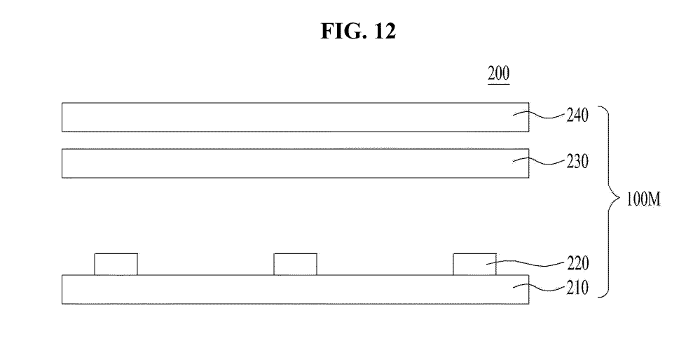

FIG. 12 is a cross-sectional view showing a lighting apparatus 200 according to one embodiment.

The lighting apparatus 200 shown in FIG. 12 may include a substrate 210, a plurality of light sources 220, a second lens 230, and an optical member 240.

The plurality of light sources 220 shown in FIG. 12 are arranged on the substrate 210. Here the light sources 220 and the substrate 210 may correspond respectively to the light sources 120 and the base 110 shown in FIG. 1. In this case, for example, when the light sources 220 and the substrate 210 shown in FIG. 12 are realized as shown in FIG. 2, an additional PCB (not shown) may be arranged below the substrate 210. Here, the PCB has the same configuration as the PCB 110B shown in FIG. 3, and thus description of the same components is omitted for clarity.

In addition, the substrate 210 and the light sources 220 may correspond to the substrate 110B and the light sources LS4, LS5, and LS6 shown in FIG. 3, respectively, and thus description of the same components is omitted for clarity. In this case, the light emitting module 100M according to one embodiment may further include a second lens 230 in addition to a substrate 210 and a plurality of light sources 220. The second lens 230 may be arranged on a plurality of LED packages corresponding to the light sources 220. Optionally, the second lens 230 may be omitted.

The optical member 240 may be arranged above the light emitting module 100M. The optical member 240 serves to diffuse light emitted from the plurality of light sources 220. In this case, an uneven pattern may also be formed on a top surface of the optical member 240 to enhance a light diffusion effect.

The optical member 240 may be formed in a single-layered or multilayered structure, and the uneven pattern may be formed on a surface of the uppermost layer or any one of the multiple layers. The uneven pattern may have a stripe shape arranged on the light emitting module 100M.

Optionally, the optical member 240 may be made of at least one sheet. For example, the optical member 240 may optionally include a diffusion sheet, a prism sheet, a brightness enhancement sheet, etc. The diffusion sheet serves to diffuse light emitted from the plurality of light sources 220. The prism sheet serves to guide the diffused light to a light emitting region. The brightness enhancement sheet serves to enhance brightness.

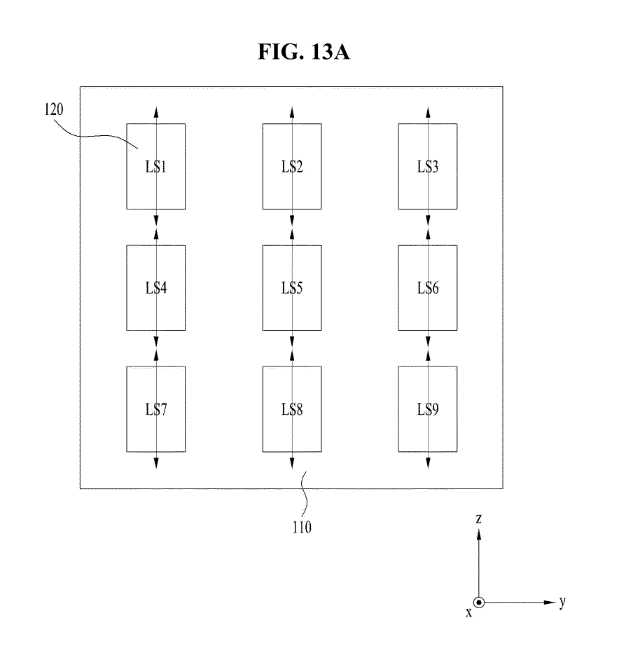

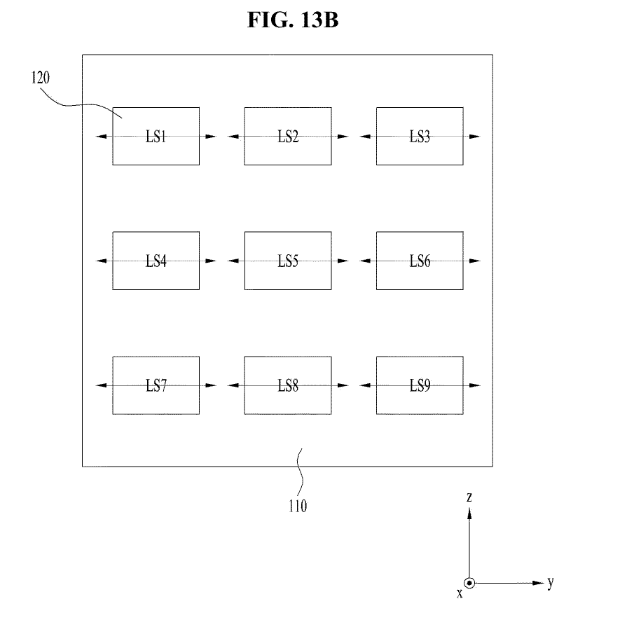

FIGS. 13A and 13B are plan views showing light emitting modules according to one comparative embodiment.

Each of the light emitting modules according to the comparative embodiment shown in FIGS. 13A and 13B includes a base 110 and a plurality of light sources 120. Unlike the light emitting modules according to the embodiments, the long-axis directions of the plurality of light sources 120 in the light emitting modules according to the comparative embodiment are not alternately changed in any direction, but may be maintained in the same direction as a z-axis direction, as shown in FIG. 13A, or may be maintained in the same direction as a y-axis direction, as shown in FIG. 13B. Additionally, in the light emitting modules according to the comparative embodiment, the short-axis directions of the plurality of light sources 120 are not alternately changed in any direction, but may be maintained in the same direction as a y-axis direction, as shown in FIG. 13A, or may be maintained in the same direction as a z-axis direction, as shown in FIG. 13B.

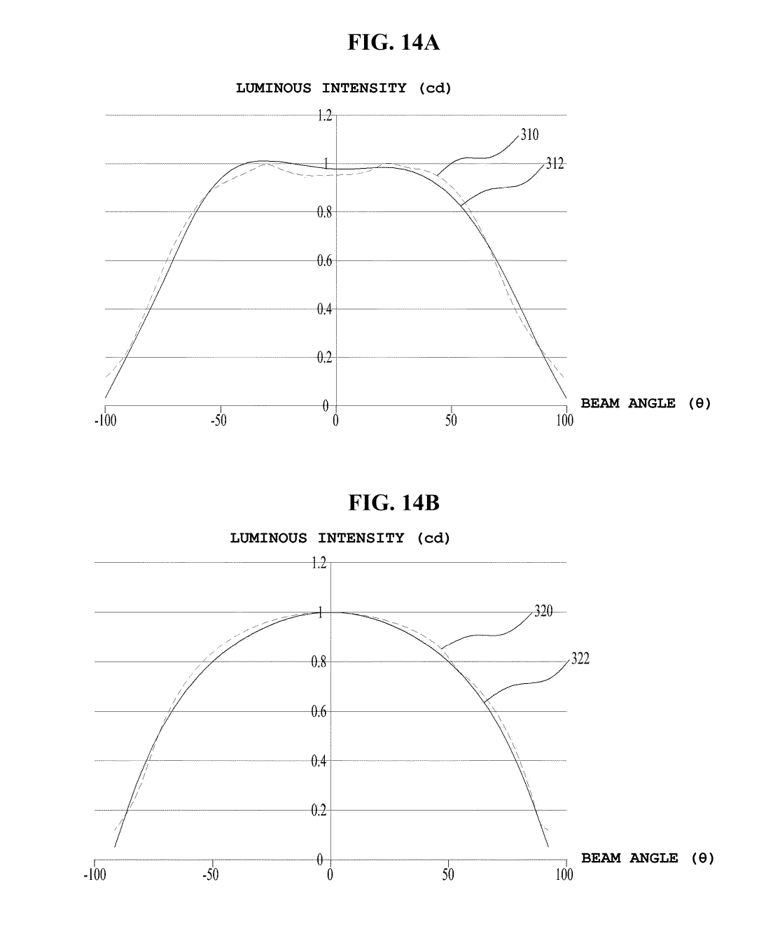

FIGS. 14A and 14B are diagrams showing short-axis and long-axis light distributions of LEDs having a rectangular planar shape, respectively. In each graph, a horizontal axis represents a beam angle (A), and a longitudinal axis represents a luminous intensity. Here, the unit of luminous intensity is given in candela (cd), reference numerals 310 and 320 represent simulation results, and reference numerals 312 and 322 represent actually measured results.

Referring to FIGS. 14A and 14B, it can be seen that, when the LED has a rectangular planar shape, the light distributions (or beam angles) on the long and short axes of the LED may be different from each other.

In addition, although the LED has a square planar shape, the light distributions on the long and short axes of one LED package may be different from each other when a plurality of square light emitting diodes are arranged in single LED package in a single direction.

The light distributions as described above may be more seriously distorted when the wavelength conversion unit 130 is disposed or when the second lens 230 is disposed on the first lens 140. As a result, when all of the long-axis and short-axis directions of the light source 120 are the same as shown in FIGS. 13A and 13B, the light distributions are more seriously distorted. In the case of the light emitting modules 100A to 100M according to the embodiments, the plurality of light sources 120 are arranged so that at least one of the long-axis or short-axis direction of the light sources 120 is alternately changed in at least one of the column or row direction. Therefore, the light emitting modules 100A to 100M according to the embodiments may offset the different light distributions in long-axis and short-axis directions, and thus may have a superior light distribution, compared to the light emitting modules according to the comparative embodiment.

In addition, a lighting apparatus with a predetermined size may be realized using a plurality of light emitting modules. In this case, uniformity in light distribution in the lighting apparatus may be degraded due to difference in light distribution in the light emitting modules.

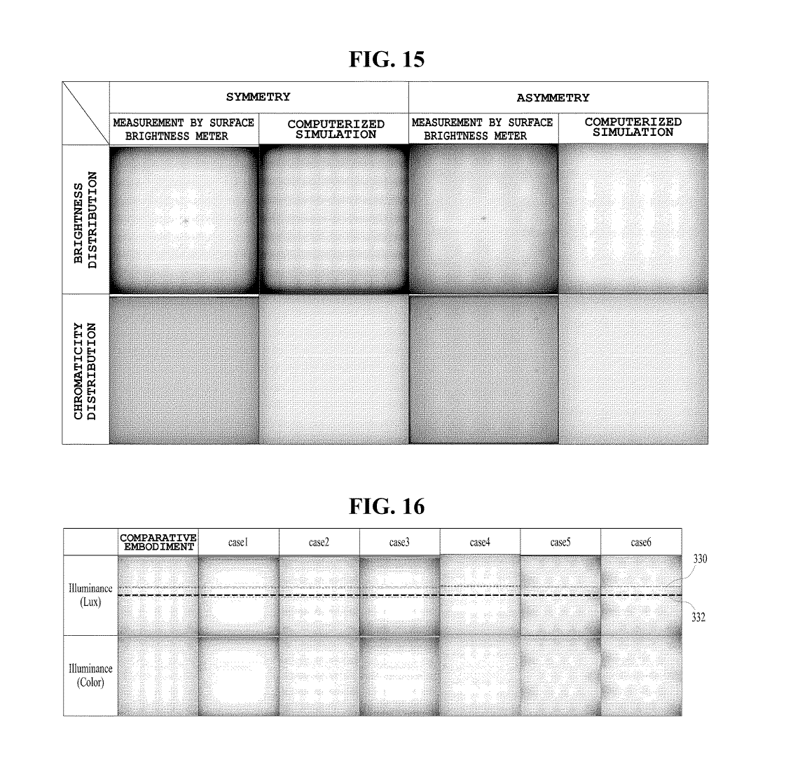

FIG. 15 is a diagram showing brightness distributions and chromaticity distributions of symmetrical and asymmetrical lighting apparatuses according to the comparative embodiment. Here, the symmetrical lighting apparatus according to the comparative embodiment includes 64 square LED packages, and the asymmetrical lighting apparatus according to the comparative embodiment includes 255 rectangular LED packages.

Referring to FIG. 15, it can be seen that the symmetrical lighting apparatus according to the comparative embodiment has superior brightness and chromaticity distributions, compared to the asymmetrical lighting apparatus according to the comparative embodiment. In particular, it can be seen that the light sources are present in bright zones, and patterns are formed at zones between the light sources, as shown in FIG. 15.

FIG. 16 is a diagram showing in-plane brightness (Lux) and in-plane chromaticity (Color) distributions of the lighting apparatuses according to the comparative embodiment and the embodiments. Here, reference numeral 330 represents a zone between the light sources 120, and reference numeral 332 represents an upper surface (or, top) surface of the light source 120.

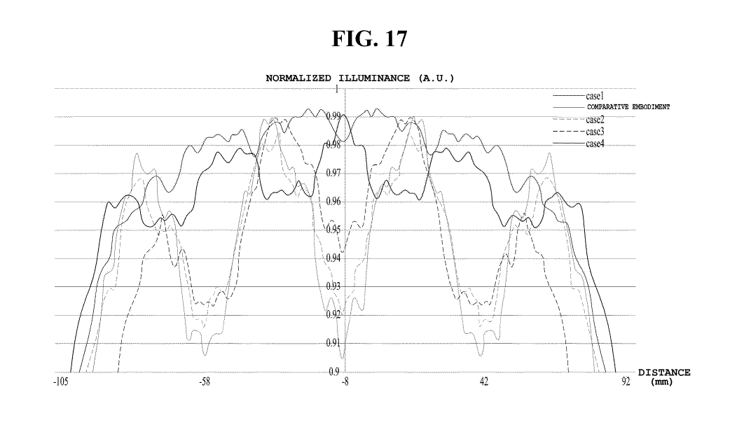

FIG. 17 is a graph showing illuminance distributions of the lighting apparatuses according to the comparative embodiment and the embodiments (Cases 1 to 4) as shown in FIG. 16. Here, a horizontal axis represents a distance (mm), and a longitudinal axis represents a normalized illuminance. The number “0” on the horizontal axis represents the center of the lighting apparatus.

In FIG. 16, the comparative embodiment shows that the light sources 120 are arranged as shown in FIG. 13A, and have a pitch P of 54 mm.

To obtain the image shown in FIG. 16, the six different lighting apparatuses according to the embodiments are realized (Cases 1 to 6).

Case 1 shows that each of the plurality of light sources included in the lighting apparatus according to one embodiment has a short-axis length of 51 mm, a long-axis length of 52 mm, and a pitch P of 33.75 mm, and the light sources 120 are arranged in a square planar shape, as shown in FIG. 1.

Case 2 shows that the number of the light sources included in the lighting apparatus according to the embodiment is 25, and the light sources have a pitch P of 54 mm, and are arranged as shown in FIG. 1.

Case 3 shows that the number of the light sources included in the lighting apparatus according to the embodiment is 25, and the light sources have a pitch P of 50 mm, and are arranged as shown in FIG. 1.

Case 4 shows that the number of the light sources included in the lighting apparatus according to the embodiment is 36, and the light sources have a pitch P of 45 mm, and are arranged as shown in FIG. 1.

Case 5 shows that the number of the light sources included in the lighting apparatus according to the embodiment is 25, and the light sources have a pitch P of 54 mm, and are arranged in a diamond-type shape as shown in FIG. 11.

Case 6 shows that the number of the light sources included in the lighting apparatus according to the embodiment is 25, and the light sources are arranged in a diamond-type shape, as shown in FIG. 11.

Referring to FIGS. 16 and 17, while a difference in illuminance between bright and dark zones amounts to approximately 9% in the case of the comparative embodiment, differences in illuminance between the bright and dark zones amount to approximately 7% and 3% in the case of the embodiments (Cases 2 and 3) and the embodiment (Case 4), respectively, indicating that the difference in illuminance in the lighting apparatuses according to the embodiments is relatively low, compared to the lighting apparatus according to the comparative embodiment.

As is apparent from the above description, when the lighting apparatus according to the embodiments is realized using the light emitting module in which the light sources are arranged to offset the light distributions in long-axis and short-axis directions, uniformity may be improved due to uniform brightness and chromaticity distributions, and thus manufacturing costs may be reduced, and efficiency may be enhanced.

The light emitting module according to the embodiments, and the lighting apparatus including the same have uniform brightness and chromaticity distributions, and thus can be manufactured at low manufacturing cost and high efficiency.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A light emitting module comprising:
a base; and
a plurality of light sources arranged on the base,
wherein at least some of the plurality of light sources have a rectangular planar shape, and
wherein the plurality of light sources are arranged so that at least one of long-axis direction or short-axis direction of at least some of the plurality of light sources are alternately changed in at least one of row direction or column direction.

2. The light emitting module of claim 1, wherein the base corresponds to a package body having the plurality of light sources arranged thereon, and
the plurality of light sources correspond to a plurality of light emitting devices, respectively.

3. The light emitting module of claim 1, wherein the base corresponds to a printed circuit board (PCB) having the plurality of light sources arranged thereon, and
the plurality of light sources correspond to a plurality of LED packages, respectively.

4. The light emitting module of claim 3, wherein each of the plurality of LED packages comprises:
a package body arranged on the PCB; and
at least one light emitting device arranged on the package body.

5. The light emitting module of claim 4, wherein each of the plurality of LED packages further comprises:
a first lens arranged on the package body; and
a wavelength conversion unit arranged between the first lens and the package body.

6. The light emitting module of claim 4, wherein the at least one light emitting device comprises a plurality of light emitting devices, and
the plurality of light emitting devices have at least one of square planar shape or rectangular planar shape.

7. The light emitting module of claim 1, wherein the plurality of light sources are arranged in at least one shape selected from the group consisting of polygonal, diamond-type, and shift-type shapes to be spaced apart from each other.

8. The light emitting module of claim 1, wherein at least some of the plurality of light sources are arranged spaced apart from each other by the same intervals in at least one of row direction or column direction.

9. The light emitting module of claim 1, wherein at least some of the plurality of light sources are arranged spaced apart from each other by different intervals in at least one of row direction or column direction.

10. The light emitting module of claim 1, wherein a spacing between the plurality of light sources arranged in the row direction is different from a spacing between the plurality of light sources arranged in the column direction.

11. The light emitting module of claim 1, wherein the plurality of light sources are divided into columns of plural light sources arranged in a row direction, and
the plurality of light sources are arranged so that at least one of short-axis direction or long-axis direction of the neighboring ones of the columns of plural light sources is changed in a row direction.

12. The light emitting module of claim 11, wherein the columns of plural light sources are arranged so that the columns of even-numbered light sources are shifted by a predetermined distance in the column direction with respect to the columns of odd-numbered light sources.

13. The light emitting module of claim 12, wherein the predetermined distance is a half of a unit pitch by which a plurality of light sources belonging to each of the columns of light sources are spaced apart from each other in the column direction.

14. The light emitting module of claim 1, wherein the plurality of light sources are divided into rows of plural light sources arranged in a column direction, and
the plurality of light sources are arranged so that at least one of short-axis directions or long-axis directions of the neighboring ones of the rows of plural light sources is changed in a column direction.

15. The light emitting module of claim 14, wherein the rows of plural light sources are arranged so that the rows of even-numbered light sources are shifted by a predetermined distance in the column direction with respect to the rows of odd-numbered light sources.

16. The light emitting module of claim 15, wherein the predetermined distance is a half of a unit pitch by which a plurality of light sources belonging to each of the rows of light sources are spaced apart from each other in the row direction.

17. The light emitting module of claim 1, wherein each of the plurality of light sources comprises;
a central light source; and
peripheral light sources surrounding the central light source.

18. The light emitting module of claim 17, wherein the short-axis direction of the central light source is identical to the long-axis direction of the peripheral light sources.

19. The light emitting module of claim 17, wherein the long-axis direction of the central light source is identical to the short-axis direction of the peripheral light sources.

20. A lighting apparatus comprising:
the light emitting module defined in claim 1; and
an optical member arranged on the light emitting module.
